(19) United States
(12) Patent Application Publication
(10) Pub. No.: US 2014/0358280 A1
(43) Pub. Date: Dec. 4, 2014

(54) ROBOT ARM CONTROL APPARATUS, SUBSTRATE TRANSFER APPARATUS, SUBSTRATE PROCESSING APPARATUS, ROBOT ARM CONTROL METHOD, AND PROGRAM

(71) Applicant: EBARA CORPORATION, Tokyo (JP)

(72) Inventor: Hiroyuki SHINOZAKI, Tokyo (JP)

(73) Assignee: EBARA CORPORATION, Tokyo (JP)

(21) Appl. No.: 14/290,127

(22) Filed: May 29, 2014

(30) Foreign Application Priority Data
May 31, 2013 (JP) 2013-115095

(51) Int. Cl. G05B 19/416; B25J 11/00

(52) U.S. Cl. CPC G05B 19/416; B25J 11/0095
USPC 700/245

(57) ABSTRACT

A robot arm control apparatus for controlling the operation of a robot arm device having at least two arm portions and at least two rotational joints configured to rotate the arm portions includes a control unit configured to control rotation of the joints to move generally rectilinearly the distal end of a predetermined arm portion of the arm portions except the most proximal arm portion thereof. The control unit controls the rotation of the joints so that the motion acceleration of the distal end of the predetermined arm portion when the distal end is moved generally rectilinearly results in coincidence with a predetermined temporal transition. The motion acceleration with the predetermined temporal transition is such that, when the motion acceleration is expressed as a function of time, a derivative obtained by differentiating the function with respect to the time shows a continuous transition with respect to changes in the time.

### CROSS-REFERENCE TO RELATED APPLICATIONS

This application claims priority under 35 U.S.C. 119 on Patent Application No. 2013-115095 filed in Japan on May 31, 2013, the disclosure of which is hereby incorporated by reference herein in its entireties.

### TECHNICAL FIELD

The present invention relates to a robot arm control technique.

### BACKGROUND ART

Semiconductor product manufacturing processes use various transfer apparatuses to transfer substrates such as wafers. SCARA (Selective Compliance Assembly Robot Arm) type arm robots may be used as the above-described transfer apparatuses. Many of SCARA type arm robots realize arm extending and retracting (unfolding and folding) motions with a single rotational power source.

For example, an arm robot pivots a first arm portion with rotational power derived from a combination of an AC servo-motor and a speed reducer. In the arm robot, a first pulley is fixed to an end of the first arm portion closer to a driving shaft thereof. The distal end of the first arm portion is provided with a second pulley supported by a bearing. The first pulley and the second pulley are connected with a timing belt. The second pulley is restrained in the rotational direction relative to the pivot center (root) of a second arm portion. As the second pulley rotates, the second arm portion pivots. An end of the second arm portion closer to the pivot center thereof is provided with a third pulley. The third pulley is fixed to the second arm portion. The distal end of the second arm portion is provided with a fourth pulley supported by a bearing. The third pulley and the fourth pulley are connected with a timing belt. The fourth pulley is restrained in the rotational direction relative to the pivot center (root) of a hand located at the distal end of the second arm portion.

With such a robot arm, when a command for moving from the present angle is given to a rotational power source located at the root of the first arm portion, the first arm portion is caused to pivot by rotational power, and at substantially the same time, the second arm portion pivots in the direction opposite to the pivoting direction of the first arm portion. The trajectory of the distal end of the second arm portion is rectilinear, ideally speaking When the robot arm is used to transfer a substrate placed on the hand, the rotational power source is operatively controlled on the basis of a preset angular displacement and rotational angular velocity of the rotating shaft. The rotational angular velocity of the rotating shaft is generally set to change trapezoidally with time.

### SUMMARY OF INVENTION

One embodiment of the present invention provides a robot arm control apparatus for controlling the operation of a robot arm device having at least two arm portions and at least two rotational joints configured to rotate the at least two arm portions, respectively. The robot arm control apparatus has a control unit configured to control the rotation of the at least two rotational joints to move generally rectilinearly the distal end of a predetermined arm portion of the at least two arm portions except a most proximal arm portion thereof. The control unit controls the rotation of the at least two rotational joints so that the motion acceleration of the distal end of the predetermined arm portion when the distal end is moved generally rectilinearly results in coincidence with a predetermined temporal transition. The motion acceleration with the predetermined temporal transition is such that, when the motion acceleration is expressed as a function of time, a derivative obtained by differentiating the function with respect to the time shows a continuous transition with respect to changes in the time.

### BRIEF DESCRIPTION OF DRAWINGS

FIG. 1 is a plan view schematically showing the structure of a substrate polishing system as an embodiment of the present invention.

FIGS. 2(A) and 2(B) are explanatory views schematically showing the structure of a robot arm device.

FIGS. 3(A) and 3(B) are explanatory views showing the way in which the robot arm device shown in FIGS. 2(A) and 2(B) operates.

FIG. 4 is a graph showing an example of the motion trajectories of first and second arm portions.

FIG. 5 is a graph showing an example of a predetermined temporal transition of a motion acceleration of the distal end of the second arm portion.

FIG. 6 is a graph showing an example of the results of calculations performed to determine the moving velocity of the distal end of the second arm portion and the respective displacements of the first and second arm portions from the temporal transition of the motion acceleration of the distal end of the second arm portion.

FIG. 7 is a graph showing an example of the results of calculations performed to determine the angles, angular velocities and angular accelerations of the rotating shafts of the first and second arm portions from the displacements of the first and second arm portions.

FIG. 8 is a graph showing an example of the motion parameters of the first and second arm portions as a comparative example.

FIG. 9 is a graph showing an example of the motion parameters of the first and second arm portions as a comparative example.

### DESCRIPTION OF EMBODIMENTS

A first embodiment of the present invention provides a robot arm control apparatus for controlling the operation of a robot arm device. The robot arm control apparatus includes at least two arm portions and at least two rotational joints configured to rotate the at least two arm portions, respectively. The robot arm control apparatus includes a control unit configured to control the rotation of the at least two rotational joints to move generally rectilinearly the distal end of a predetermined arm portion of the at least two arm portions except a most proximal arm portion thereof. The control unit controls the rotation of the at least two rotational joints so that the motion acceleration of the distal end of the predetermined arm portion when the distal end is moved generally rectilinearly results in coincidence with a predetermined temporal transition. The motion acceleration with the predetermined temporal transition is such that, when the motion acceleration is expressed as a function of time, a derivative obtained by differentiating the function with respect to the time shows a continuous transition with respect to changes in the time.

The above-described robot arm control apparatus allows the motion acceleration of the predetermined arm portion to change smoothly. Consequently, it is possible to suppress high-frequency acceleration and deceleration from acting on the robot arm device. Accordingly, it is possible to reduce vibration during transfer with the robot arm device.

According to a second embodiment of the present invention, the motion acceleration A(t) as the function of time described in the first embodiment of the present invention satisfies the following expression:

A(t)=A0·sin(ωt)

where:

A0 is a constant;

T is a time taken to move the distal end of the predetermined arm portion generally rectilinearly from a starting point to an end point; and

ω=2πf, where f=1/T.

The second embodiment of the present invention allows the motion acceleration of the predetermined arm portion to change very smoothly. If the time T is set so that the frequency f of reaction force acting on a fixed portion of the robot arm device is lower than the mechanical resonance frequency of the fixed portion of the robot arm device, transfer can be performed without exciting a mechanical resonant mode.

According to a third embodiment of the present invention, the motion acceleration A(t) described in the first embodiment of the present invention satisfies the following expression:

A(t)=A0·sin²(ωt)

The third embodiment of the present invention offers advantages substantially equivalent to those of the second embodiment of the present invention.

According to a fourth embodiment of the present invention, a fundamental frequency f0 of frequency components of the motion acceleration described in the first embodiment of the present invention is set so that neither of f0 and n times f0 (n is a positive integer) coincides with any of the resonant frequencies of the arm portions and a fixed portion of the robot arm device. With the fourth embodiment of the present invention, when the frequency of reaction force acting on the fixed portion of the robot arm device includes a frequency component of fundamental frequency f0 and a frequency component of n times f0, it is possible to suppress the excitation of a mechanical resonant mode for either of the frequency components.

A fifth embodiment of the present invention provides a substrate transfer apparatus. The substrate transfer apparatus includes a robot arm device configured to transfer a substrate and the robot arm control apparatus of any one of the first to fourth embodiments of the present invention. A sixth embodiment of the present invention provides a substrate processing apparatus having the substrate transfer apparatus of the fifth embodiment of the present invention. A seventh embodiment of the present invention provides a robot arm control method. The method includes predetermining a temporal transition of motion acceleration of the distal end of a predetermined arm portion of at least two arm portions except a most proximal arm portion thereof when the distal end is moved generally rectilinearly so that, when the motion acceleration is expressed as a function of time, a derivative obtained by differentiating the function with respect to the time shows a continuous transition with respect to changes in the time, and controlling the rotation of at least two rotational joints so that the motion acceleration of the distal end of the predetermined arm portion when the distal end is moved generally rectilinearly results in coincidence with the predetermined temporal transition. An eighth embodiment of the present invention provides a program for controlling the operation of a robot arm device. The program causes a computer to perform controlling rotation of at least two rotational joints to move generally rectilinearly the distal end of a predetermined arm portion of at least two arm portions except a most proximal arm portion thereof. The controlling the rotation of the at least two rotational joints is performed so that the motion acceleration of the distal end of the predetermined arm portion, except the most proximal arm portion, when the distal end is moved generally rectilinearly results in coincidence with a predetermined temporal transition. The motion acceleration with the predetermined temporal transition is such that, when the motion acceleration is expressed as a function of time, a derivative obtained by differentiating the function with respect to the time shows a continuous transition with respect to changes in the time. A ninth embodiment of the present invention provides a computer-readable recording medium recorded with the program of the eighth embodiment of the present invention. The fifth to ninth embodiments of the present invention offer advantages similar to those of the first embodiment of the present invention. It should be noted that the first to fourth embodiments of the present invention are also applicable to the sixth to ninth embodiments of the present invention. Hereinafter, more specific embodiments will be described.

### A. Embodiments

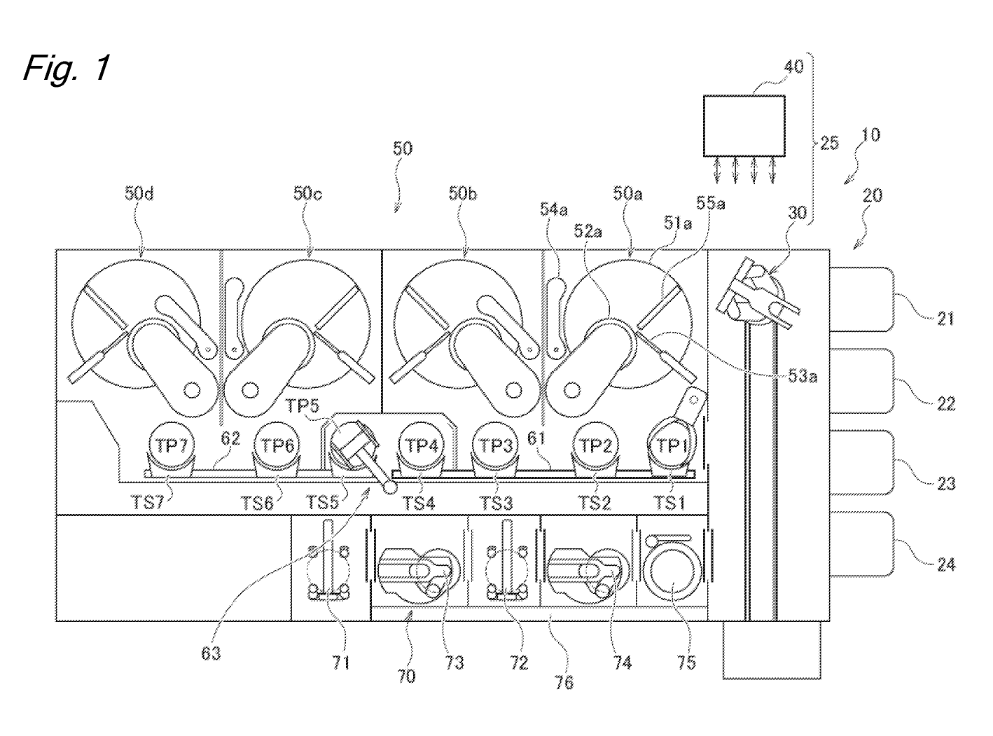

FIG. 1 is a plan view schematically showing the structure of a CMP (Chemical-Mechanical Polishing) system 10 as one example of a substrate processing apparatus according to the present invention. As shown in FIG. 1, the CMP system 10 has a loading/unloading section 20, a polishing section 50, and a cleaning section 70. The loading/unloading section 20 has four front loading units 21 to 24 and a substrate transfer apparatus 25. The front loading units 21 to 24 is used to put wafer cassettes stocking wafers as a kind of substrate thereon. The front loading units 21 to 24 may include open cassettes, SMIF (Standard Mechanical Interface) pod, or FOUP (Front Opening Unified Pod).

The substrate transfer apparatus 25 has a robot arm device 30, and a robot arm control apparatus 40. The robot arm device 30 has two robot arms and is movable on a traveling mechanism provided along the row of the front loading units 21 to 24. The robot arm device 30 is used to deliver wafers between the wafer cassettes of the front loading units 21 to 24 and a first linear transporter 61 (described later). The two robot arms of the robot arm device 30 are vertically spaced from each other. The lower robot arm is used to take out an unprocessed wafer from a wafer cassette, and the upper robot arm is used to return a processed wafer to a wafer cassette. The robot arm control apparatus 40 controls all operations of the robot arm device 30. In this embodiment, the robot arm control apparatus 40 includes a PLC (Programmable Logic Controller), a motion controller, and a motor driver. It should, however, be noted that the robot arm control apparatus 40 is not particularly limited to the above-described structure but may be configured such that a CPU (Central Processing Unit) executes software stored in a memory to implement necessary functions.

The polishing section 50 is an area where a wafer is polished. The polishing section 50 includes a first polishing unit 50a, a second polishing unit 50b, a third polishing unit 50c, and a fourth polishing unit 50d. The first polishing unit 50a has a polishing table 51a with a polishing surface, a top ring 52a for holding and polishing a wafer while pressing the wafer against the polishing table 51a, a polishing liquid supply nozzle 53a for supplying a polishing liquid and a dressing liquid (e.g. water) to the polishing table 51a, a dresser 54a for dressing the polishing table 51a, and an atomizer 55a spraying the polishing surface with a fog of either a mixed fluid of a liquid (e.g. pure water) and a gas (e.g. nitrogen) or a liquid (e.g. pure water) from at least one nozzle. The other polishing units 50b, 50c and 50d also include the same structure as the first polishing unit 50a, although an explanation thereof is omitted.

The cleaning section 70 is an area where a polished wafer is cleaned. The cleaning section 70 includes two cleaners 71 and 72 cleaning a polished wafer, robot arm devices 73 and 74 transferring a wafer, and a drying unit 75. A wafer primarily cleaned by the cleaner 71 is transferred by the robot arm device 73 to the cleaner 72, where the wafer is secondarily cleaned. The secondarily cleaned wafer is transferred by the robot arm device 74 to the drying unit 75, where the wafer is dried.

A first linear transporter 61 is disposed between the first polishing unit 50a and the second polishing unit 50b, on the one hand, and, on the other, the cleaning section 70. The first linear transporter 61 transfers a wafer between four transfer positions along the longitudinal direction (the four transfer positions are also referred to as a “first transfer position TP1”, a “second transfer position TP2”, a “third transfer position TP3”, and a “fourth transfer position TP4”, respectively, in the order from the side closer to the loading/unloading section 20).

Beyond the fourth transfer position TP4 as seen from the loading/unloading section 20 side, a second linear transporter 62 is disposed adjacent to the first linear transporter 61. The second linear transporter 62 transfers a wafer between three transfer positions along the longitudinal direction (the three transfer positions are also referred to as a “fifth transfer position TP5”, a “sixth transfer position TP6”, and a “seventh transfer position TP7”, respectively, in the order from the loading/unloading section 20 side). Between the first linear transporter 61 and the second linear transporter 62 is disposed a swing transporter 63 transferring a wafer between the first linear transporter 61, the second linear transporter 62, and the cleaning section 70.

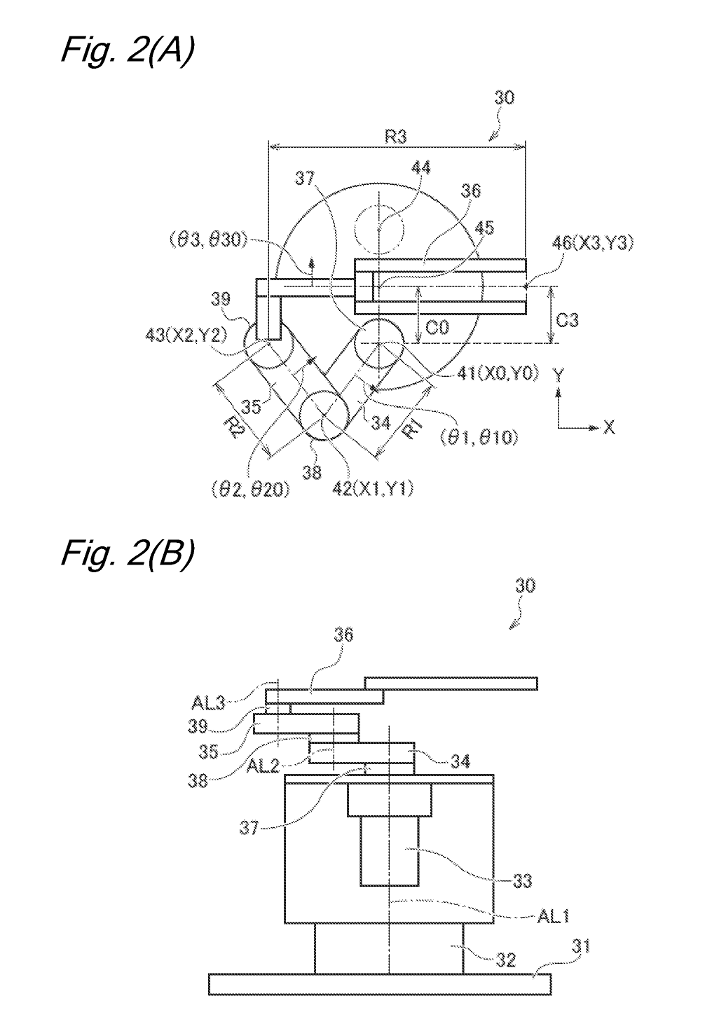

FIGS. 2(A) and 2(B) show schematically the structure of the robot arm device 30. In FIGS. 2(A) and 2(B) are shown only the lower robot arm of the two robot arms of the robot arm device 30. The robot arm device 30 includes a fixed base 31, a pivotal driving unit 32, an arm rotational driving unit 33, a first arm portion (link) 34, a second arm portion (link) 35, a hand 36, and three rotational joints 37 to 39. The pivotal driving portion 32 drives the robot arm device 30 to pivot about a pivot center 45.

The first arm portion 34 is the most proximal arm portion of the first and second arm portions 34 and 35. The first arm portion 34 is configured to be rotatable about a rotation center (arm driving center) 41 lying on an axis AU through the rotational joint 37 at the proximal end of the first arm portion 34. The second arm portion 35 is connected at the proximal end thereof to the distal end of the first arm portion 34 through the rotational joint 38. The second arm portion 35 is configured to be rotatable about a rotation center 42 lying on an axis AL2. The hand 36 is connected at the proximal end thereof to the distal end of the second arm portion 35 through the rotational joint 39. The hand 36 is configured to be rotatable about a rotation center 43 lying on an axis AL3. In the following explanation, the coordinate values of the rotation centers 41, 42 and 43 in an XY orthogonal coordinate system are represented by (X0, Y0), (X1, Y1), and (X2, Y2), respectively. In addition, the coordinate values of the distal end 46 of the hand 36 are represented by (X4, Y4). It should be noted that the other robot arm (not shown) is rotatable about an arm driving center 44.

The rotary motions of the first arm portion 34, the second arm portion 35 and the hand 36 are realized by the arm rotational driving unit 33. The arm rotational driving unit 33 includes a single servo-motor as a driving source and a speed reducer (both not shown). The arm rotational driving unit 33 transmits rotational power from the servo-motor to the first arm portion 34, the second arm portion 35, and the hand 36 through a transmission mechanism (e.g. timing belts, pulleys, gears, and so forth) including the rotational joints 37 to 39, thereby rotationally driving the first and second arm portions 34 and 35 and the hand 36. It should be noted that the arm rotational driving unit 33 may have two or more driving sources, and that driving forces may be independently applied to at least two of the first arm portion 34, the second arm portion 35 and the hand 36.

Regarding the robot arm device 30, as shown in FIG. 2(A), the pivot angles of the first arm portion 34, the second arm portion 35 and the hand 36 are denoted by θ1, θ2 and θ3, respectively. The initial angles of the first arm portion 34, the second arm portion 35 and the hand 36 are denoted by θ10, θ20 and θ30, respectively. In addition, the lengths of the first arm portion 34, the second arm portion 35 and the hand 36 are denoted by R1, R2 and R3, respectively. R1 is equal to the distance between the rotation centers 41 and 42. R2 is equal to the distance between the rotation centers 42 and 43. R3 is equal to the distance between the rotation center 43 and the distal end 46 in the X-axis direction. In addition, the distance between the pivot center 45 and the arm driving center 41 is denoted by C0, and the offset quantity of the hand 36 in the Y-axis direction is denoted by C3.

With the above denotations, the relationship between the pivot angle of the first arm portion 34 and the coordinates of the rotation center 42 is given by the following expressions (1) and (2). The relationship between the pivot angle of the second arm portion 35 and the coordinates of the rotation center 43 is given by the following expressions (3) and (4). In addition, the relationship between the pivot angle of the hand 36 and the coordinates of the distal end 46 of the hand 36 is given by the following expressions (5) and (6):

X1=R1·COS(θ10+θ1) (1)

Y1=R1·SIN(θ10+θ1) (2)

X2=R2·COS(θ20−θ2+θ1)+X1 (3)

Y2=R2·SIN(θ20−θ2+θ1)+Y1 (4)

X3=R3·COS(θ30+θ3−θ2+θ1)+X2 (5)

Y3=R3·SIN(θ30+θ3−θ2+θ1)+Y2+C3 (6)

In addition, when the robot arm device 30 operates, a disturbance torque T given by the following expression (7) acts at a certain frequency on a fixed portion of the robot arm device 30, that is, a fixed portion of the pivotal driving unit 32 (i.e. the pivot shaft (fixed shaft) of the pivotal driving unit 32 about which the arm pivots):

T=C0·F (7)

In expression (7), F is a reaction force resulting from the arm motion of the robot arm device 30. The disturbance torque T is a cause of vibration of the robot arm device 30. Particularly, when the frequency of the disturbance torque T coincides with a resonance frequency of the robot arm device 30 (including driven and fixed portions), a mechanical resonant mode is excited, which causes markedly increased vibration.

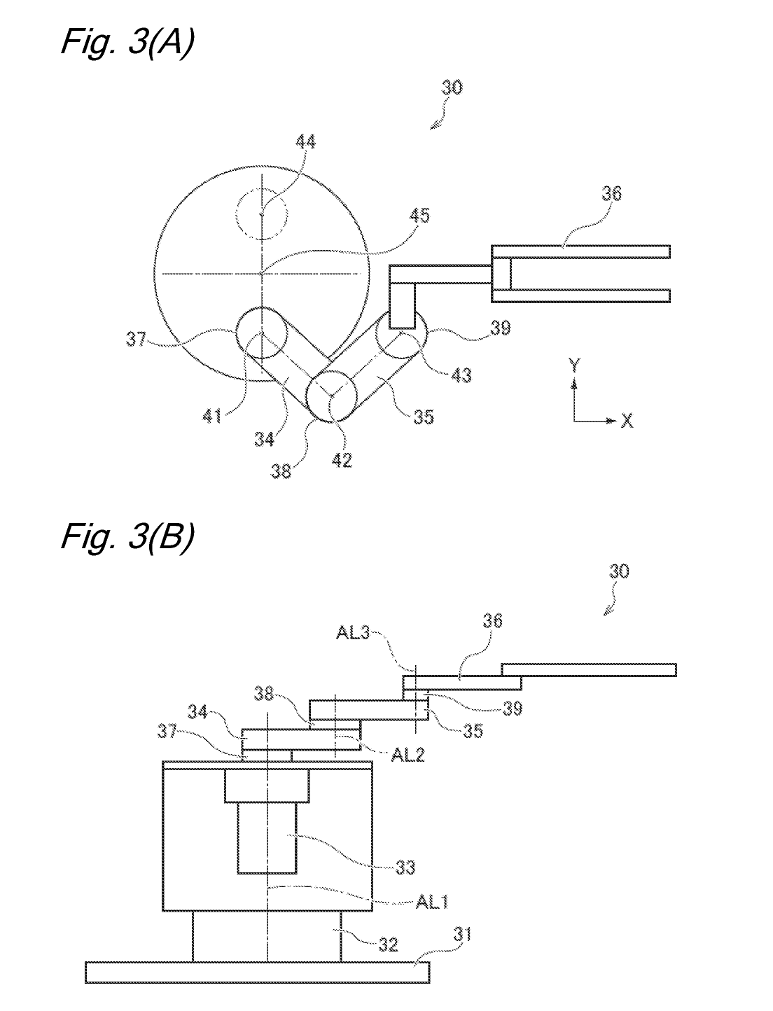

FIGS. 3(A) and 3(B) are an explanatory view showing the way in which the robot arm device 30 shown in FIGS. 2(A) and 2(B) operates. In this embodiment, as shown in FIGS. 3(A) and 3(B), the robot arm device 30 moves the distal end of the robot arm, i.e. the distal end (rotation center) 43, generally rectilinearly along the X axis, thereby conveying a wafer gripped with the hand 36. The term “generally rectilinearly” as used herein means that the trajectory of the distal end 43 lies within a range of ±5 mm with respect to a straight line parallel to the X axis. In this embodiment, the robot arm device 30 is controlled so that the trajectory of the distal end 43 becomes a completely straight line under ideal conditions. Actually, however, it is difficult to realize ideal conditions; therefore, there may be some deviation from the ideal rectilinear trajectory due to various causes, for example, the stretch of the timing belts of the transmission mechanism including the rotational joints 37 to 39. The above-mentioned term “generally rectilinear” includes rectilinear movement involving such a deviation.

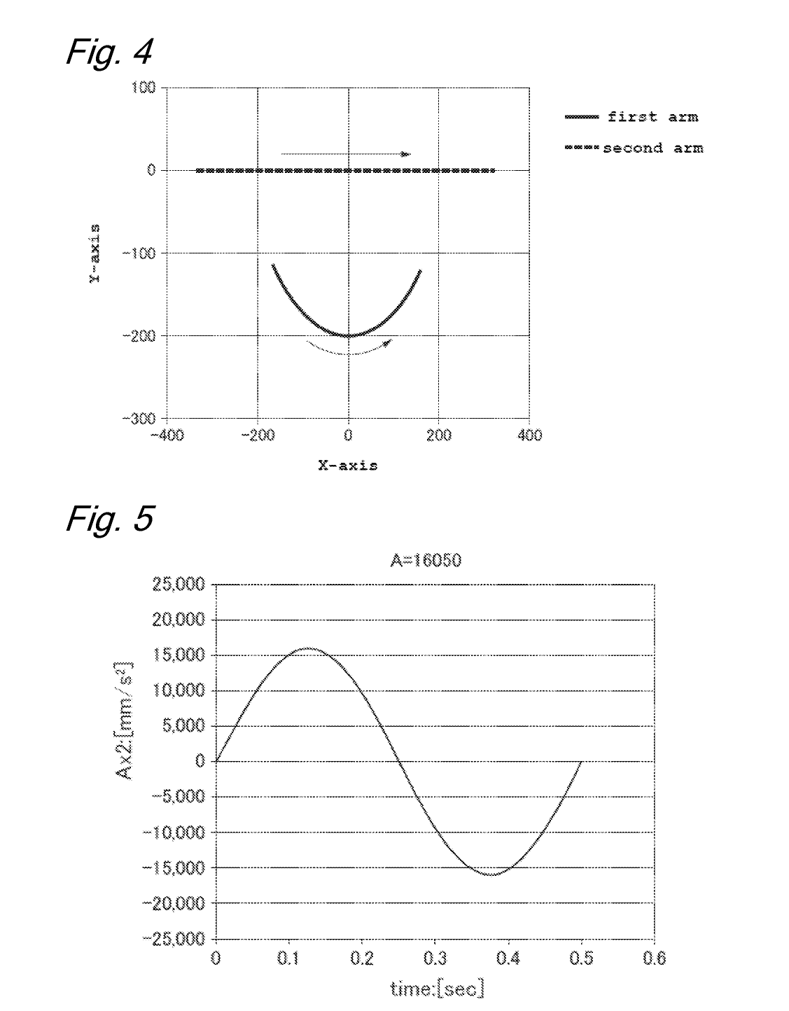

FIG. 4 shows an example of the trajectories of the distal end (rotation center 42) of the first arm portion 34 and the distal end (rotation center 43) of the second arm portion 35 in the moving operation shown in FIGS. 3(A) and 3(B). The distal end 42 of the first arm portion 34 moves along a circular arc as the first arm portion 34 rotates counterclockwise about the rotation center 41. On the other hand, the distal end 43 of the second arm portion 35 moves rectilinearly (ideally speaking) as the second arm portion 35 rotates clockwise about the rotation center 42. It should be noted that the distal end 46 of the hand 36 moves rectilinearly (ideally speaking) as the hand 36 rotates counterclockwise about the rotation center 43, although not shown. Such movement of the distal end 43 of the second arm portion 35 is realized by constructing the transmission mechanism of the arm rotational driving unit 33 so as to satisfy the relationships of θ1:θ2=1:2 and θ2:θ3=2:1 when R1=R2, for example. The above-described operation of the robot arm device 30, i.e. the operation of moving the distal end 43 of the second arm portion 35 generally rectilinearly, is controlled by the robot arm control apparatus 40 (see FIG. 1).

Specifically, the robot arm control apparatus 40 controls the motions of the first and second arm portions 34 and 35 (i.e. the rotation of the rotational joints 37 and 38) so that the motion acceleration of the distal end 43 of the second arm portion 35 when the distal end 43 is moved generally rectilinearly along the X-axis direction results in coincidence with a predetermined temporal transition. The temporal transition of the motion acceleration is set so that, when the motion acceleration is expressed as a function of time, a derivative obtained by differentiating the function with respect to the time shows a continuous transition with respect to changes in the time. In this embodiment, the motion acceleration A(t) is set so as to satisfy the following expression (8):

A(t)=A0·sin(ωt) (8)

In expression (8), A0 is a constant. In addition, ω is an angular velocity; ω=2πf, where f is a frequency. In this embodiment, f=1/T. T is a time taken to move the distal end 43 generally rectilinearly from a starting point (initial position) to an end point (target position). The constant A0 is set so that the rotation center 43 can move from the starting point to the end point within the time T.

FIG. 5 shows an example of the predetermined motion acceleration A(t) (expressed as Ax2). As shown in the figure, when the time T=0.5 sec, the frequency f=2 Hz. That is, the frequency f of the disturbance torque T acting on the fixed portion of the robot arm device 30 is 2 Hz. Usually, mechanical resonant modes are in the range of from ten-odd Hz to several tens Hz. Therefore, in this case, there is no possibility of a mechanical resonant mode being excited by the operation of the robot arm device 30. In other words, when the time T is set not less than 0.1 sec, the frequency f is not more than 10 Hz; therefore, it is possible to properly prevent excitation of a mechanical resonant mode.

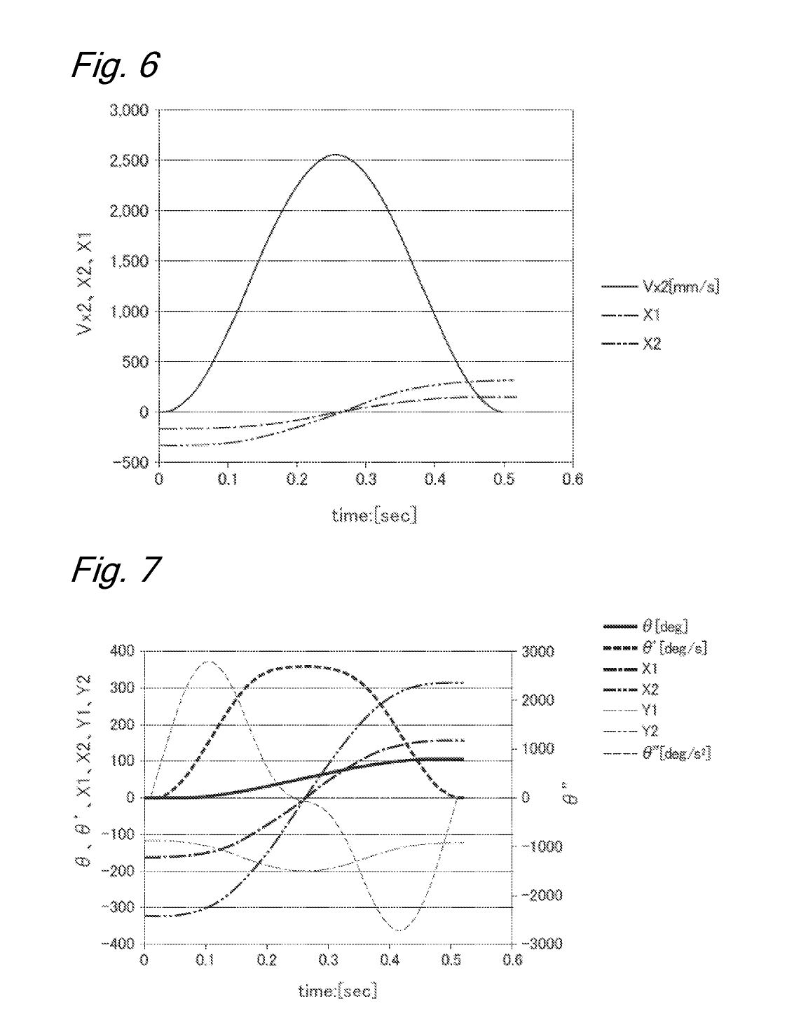

In this embodiment, the robot arm control apparatus 40 controls the rotary motions of the first arm portion 34 and the second arm portion 35 by using the pivot angle θ1 of the first arm portion 34 obtained by reverse calculation from the motion acceleration A(t) predetermined as stated above. The pivot angle θ1 can be obtained, for example, as follows. First, as shown in FIG. 6, the moving velocity Vx2 in the X-axis direction of the distal end 43 of the second arm portion 35 is obtained by reverse calculation from the motion acceleration A(t), and further, the coordinate values X1 and X2 are obtained. Further, the pivot angle θ1 of the first arm portion 34 is obtained by reverse calculation from the coordinate values X1 and X2 using the above-described expressions (1) and (3). FIG. 7 shows an example of the coordinate values X1, X2, Y1 and Y2, the pivot angle θ1, the angular velocity θ′1, and the angular acceleration θ″1 obtained by reverse calculation from the motion acceleration A(t).

A robot arm used in a semiconductor manufacturing process is demanded to reduce the transfer time from the viewpoint of improving productivity. With the conventional robot arm control method, however, if the arm is operated at high speed in order to reduce the transfer time, vibrations of the robot arm and the whole robot arm device are increased by reaction to the arm motion, which may cause falling of an object to be transferred or interference with a peripheral device. Moreover, as the vibrations increase, the settling time increases, which means that the increase in the speed of the arm operation does not contribute to an improvement in productivity, that is, a reduction in manufacturing time. Under these circumstances, there is a demand for a technique to reduce vibration during transfer with a robot arm. Such problems are not limited to the semiconductor manufacturing process but common to various processes for manufacturing and processing various products. According to the substrate transfer apparatus 25 described above, at least a part of the above-described problems can be solved.

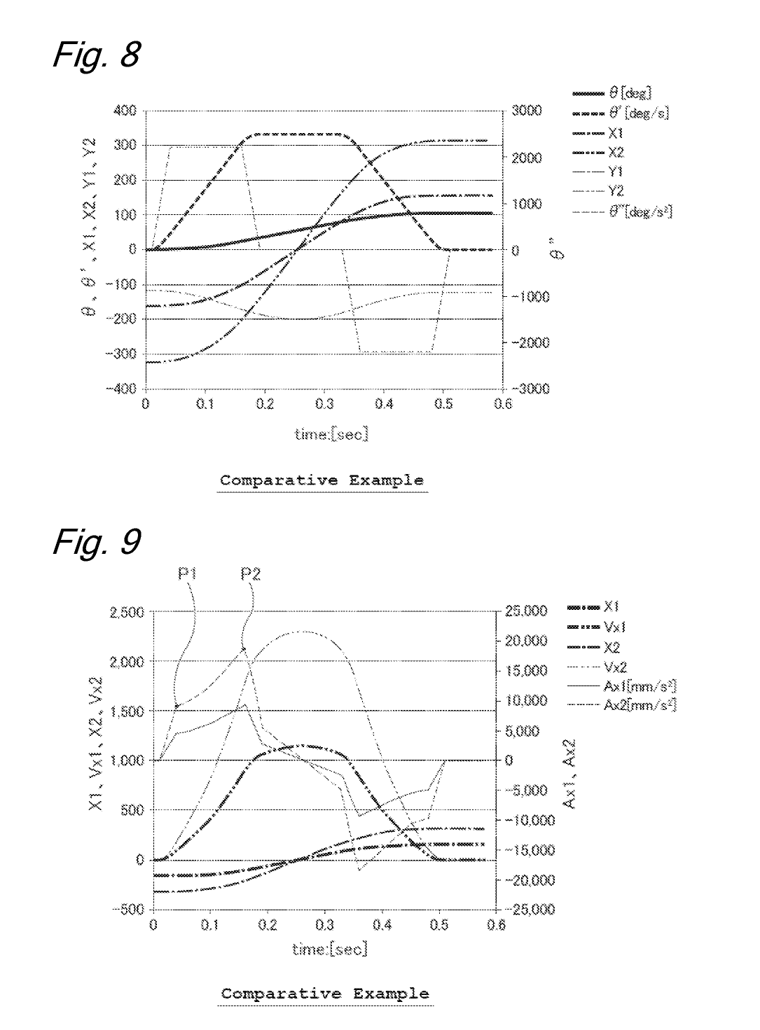

FIGS. 8 and 9 show the motion parameters of a substrate transfer apparatus using a conventional robot arm device to clarify the advantages of the substrate transfer apparatus 25 of this embodiment. As shown in FIG. 8, according to the conventional technique, a pivot angle θ1 or an angular velocity θ′1 are preset so that the curve of the angular velocity θ′1 is generally trapezoidal, and the robot arm device is controlled so that the set contents are implemented. In other words, the conventional technique puts stress on allowing a motor as a driving source to operate smoothly. Therefore, as shown in FIG. 9, the curve of the motion acceleration Ax2 of the distal end 43 of the second arm portion 35 has sharp changes where two straight lines with different slopes intersect each other as shown at points P1 and P2, for example. Such changes of the motion acceleration Ax2 cause a derivative obtained by differentiating Ax2 with respect to time to show a discrete transition with respect to changes in the time. Such motion acceleration Ax2 causes the distal end 43 of the second arm portion 35 to swing laterally, which is a major factor in causing vibration.

In contrast to the conventional technique, the substrate transfer apparatus 25 of the above-described embodiment allows the motion acceleration of the second arm portion 35 to change smoothly. As a result, high-frequency acceleration and deceleration are suppressed from acting on any of the first arm portion 34, the second arm portion 35, and the fixed portion of the robot arm device 30 (the fixed shaft of the pivotal driving unit 32), and consequently, vibration is suppressed. Accordingly, even if the transfer speed is increased in order to reduce the transfer time, it is possible to reduce the likelihood of falling of an object to be transferred and the possibility of interference with a peripheral device due to an increase in the amount of deflection. Moreover, because the vibration is suppressed, there is no increase in the settling time required for the robot arm device 30 to become ready to transfer a substrate. Accordingly, it is possible to cancel the trade-off relationship between the settling time or the amount of deflection and the transfer time reduction.

### B. Modifications

### B-1. First Modification:

The motion acceleration A(t) is not limited to the above-described expression (8) but may be set as desired so that, when the motion acceleration is expressed as a function of time, a derivative obtained by differentiating the function with respect to the time shows a continuous transition with respect to changes in the time. For example, it is possible to obtain advantages similar to those of the above-described embodiment also by setting the motion acceleration A(t) as given by the following expression (9), for example:

A(t)=A0·sin²(ωt) (9)

Alternatively, the motion acceleration A(t) may be set, for example, so that the sharp changes at points P1 and P2 are smoothed in the transition curve representing the motion acceleration Ax2 shown in FIG. 9 as a comparative example. By doing so, it is also possible to obtain a vibration suppression effect to some extent as compared with the conventional technique.

### B-2. Second Modification:

In setting of the motion acceleration A(t), the fundamental frequency f0 of the frequency components of the motion acceleration A(t) may be set so that neither of f0 and n times f0 (n is a positive integer) coincides with any of the resonant frequencies of the first arm portion 34, the second arm portion 35 and the fixed portion of the robot arm device 30. According to the arrangement, when the frequency of reaction force acting on the fixed portion of the robot arm device 30 may include a frequency component of fundamental frequency f0 and a frequency component of n times f0, it possible to suppress the excitation of a mechanical resonant mode for either of the frequency components.

### B-3. Third Modification:

The robot arm device 30 does not always need to be controlled so that the distal end 43 of the second arm portion 35 moves along a completely straight line under ideal conditions. The robot arm device 30 may be controlled so that the distal end 43 moves along a generally rectilinear trajectory, i.e. a trajectory lying within a range of ±5 mm with respect to a straight line parallel to the X axis, under ideal conditions. For example, the robot arm device 30 may be controlled so that the distal end 43 moves in a very gentle circular arc.

### B-4. Fourth Modification:

The above-described robot arm device 30 may have at least two arm portions and at least two rotational joints. For example, the robot arm device 30 may have three arm portions. In this case, the above-described method of controlling the robot arm device 30 is applicable to when to move generally rectilinearly the distal end of any arm portion except the most proximal arm portion (the first arm portion 34 in the above-described embodiment). In addition, the hand 36 may also be regarded as an arm portion.

### B-5. Fifth Modification:

The above-described various methods of controlling the robot arm device 30 are applicable not only to the robot arm device 30 but also to any substrate transfer apparatus constituting the CMP system 10. For example, the above-described control methods may also be applied to the robot arm devices 73 and 74. The above-described substrate transfer apparatus 25 is, needless to say, not only applicable to the CMP system 10 but also widely applicable to any substrate processing apparatus involving transferring substrates, e.g. a substrate deposition apparatus, a substrate etching apparatus, and so forth. Further, the substrate transfer apparatus 25 is not only applicable to transferring substrates but also widely applicable to transferring any objects to be transferred.

Although the embodiments of the present invention have been described above based on some examples, the described embodiments are for the purpose of facilitating the understanding of the present invention and are not intended to limit the present invention. The present invention may be modified and improved without departing from the gist thereof, and the invention includes equivalents thereof. In addition, the structural elements described in the claims and the specification can be arbitrarily combined or omitted within a range in which the above-mentioned problems are at least partially solved, or within a range in which at least a part of the advantages is achieved.

What is claimed is:

1. A robot arm control apparatus for controlling an operation of a robot arm device having at least two arm portions and at least two rotational joints configured to rotate the at least two arm portions, respectively, the robot arm control apparatus comprising:
a control unit configured to control rotation of the at least two rotational joints to move generally rectilinearly a distal end of a predetermined arm portion of the at least two arm portions except a most proximal arm portion thereof, the control unit controlling the rotation of the at least two rotational joints so that a motion acceleration of the distal end of the predetermined arm portion when the distal end is moved generally rectilinearly results in coincidence with a predetermined temporal transition;
wherein the motion acceleration with the predetermined temporal transition is such that, when the motion acceleration is expressed as a function of time, a derivative obtained by differentiating the function with respect to the time shows a continuous transition with respect to changes in the time.

2. The robot arm control apparatus of claim 1, wherein the motion acceleration A(t) as the function of time satisfies a following expression:
A(t)=A0·sin(ωt)
where:
A0 is a constant;
T is a time taken to move the distal end of the predetermined arm portion generally rectilinearly from a starting point to an end point; and
ω=2πf, where f=1/T.

3. The robot arm control apparatus of claim 1, wherein the motion acceleration A(t) as a function of time satisfies a following expression:
A(t)=A0·sin²(ωt)
where:
A0 is a constant;
T is a time taken to move the distal end of the predetermined arm portion generally rectilinearly from a starting point to an end point; and
ω=2πf, where f=1/T.

4. The robot arm control apparatus of claim 1, wherein a fundamental frequency f0 of frequency components of the motion acceleration is set so that neither of f0 and n times f0 (n is a positive integer) coincides with any of resonant frequencies of the robot arm device and a fixed portion of the robot arm device.

5. A substrate transfer apparatus comprising:
a robot arm device configured to transfer a substrate, the robot arm device having at least two arm portions and at least two rotational joints configured to rotate the at least two arm portions, respectively; and
a robot arm control apparatus including a control unit configured to control rotation of the at least two rotational joints to move generally rectilinearly a distal end of a predetermined arm portion of the at least two arm portions except a most proximal arm portion thereof, the control unit controlling the rotation of the at least two rotational joints so that a motion acceleration of the distal end of the predetermined arm portion when the distal end is moved generally rectilinearly results in coincidence with a predetermined temporal transition,
wherein the motion acceleration with the predetermined temporal transition is such that, when the motion acceleration is expressed as a function of time, a derivative obtained by differentiating the function with respect to the time shows a continuous transition with respect to changes in the time.

6. The substrate transfer apparatus of claim 5, wherein the motion acceleration A(t) as the function of time satisfies a following expression:
A(t)=A0·sin(ωt)
where:
A0 is a constant;
T is a time taken to move the distal end of the predetermined arm portion generally rectilinearly from a starting point to an end point; and
ω=2πf, where f=1/T.

7. The substrate transfer apparatus of claim 5, wherein the motion acceleration A(t) as a function of time satisfies a following expression:
A(t)=A0·sin²(ωt)
where:
A0 is a constant;
T is a time taken to move the distal end of the predetermined arm portion generally rectilinearly from a starting point to an end point; and
ω=2πf, where f=1/T.

8. The substrate transfer apparatus of claim 5, wherein a fundamental frequency f0 of frequency components of the motion acceleration is set so that neither of f0 and n times f0 (n is a positive integer) coincides with any of resonant frequencies of the robot arm device and a fixed portion of the robot arm device.

9. A robot arm control method for controlling an operation of a robot arm device, the robot arm control method comprising:
providing a robot arm device having at least two arm portions and at least two rotational joints configured to rotate the at least two arm portions, respectively, predetermining a temporal transition of motion acceleration of a distal end of a predetermined arm portion of the at least two arm portions except a most proximal arm portion thereof when the distal end is moved generally rectilinearly so that, when the motion acceleration is expressed as a function of time, a derivative obtained by differentiating the function with respect to the time shows a continuous transition with respect to changes in the time; and
controlling the rotation of the at least two rotational joints so that the motion acceleration of the distal end of the predetermined arm portion when the distal end is moved generally rectilinearly results in coincidence with the predetermined temporal transition.

10. The robot arm control method of claim 9, wherein the motion acceleration A(t) as the function of time satisfies a following expression:
A(t)=A0·sin(ωt)
where:
A0 is a constant;
T is a time taken to move the distal end of the predetermined arm portion generally rectilinearly from a starting point to an end point; and
ω=2πf, where f=1/T.

11. The robot arm control method of claim 9, wherein the motion acceleration A(t) as a function of time satisfies a following expression:
A(t)=A0·sin²(ωt)
where:
A0 is a constant;
T is a time taken to move the distal end of the predetermined arm portion generally rectilinearly from a starting point to an end point; and
ω=2πf, where f=1/T.

12. The robot arm control method of claim 9, wherein a fundamental frequency f0 of frequency components of the motion acceleration is set so that neither of f0 and n times f0 (n is a positive integer) coincides with any of resonant frequencies of the robot arm device and a fixed portion of the robot arm device.
